(19) United States
(12) Patent Application Publication
(10) Pub. No.: US 2007/0196016 A1
(43) Pub. Date: Aug. 23, 2007

(54) Calibration system for image capture apparatus and method thereof

(76) Inventors: I-Hsien Chen, Fongshan City (TW); Sheng-Jyh Wang, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/483,542

(22) Filed: Jul. 11, 2006

(30) Foreign Application Priority Data
Feb. 21, 2006 (TW) 95105830

(51) Int. Cl. G06K 9/46

(52) U.S. Cl. 382/190

(57) ABSTRACT

A calibration system and a method to be used in an image capture apparatus are disclosed. The calibration system includes a calibration appliance, a feature extraction unit and a processor. The calibration appliance has a plurality of mark points. The plurality of mark points is on the same plane to form a line segment with a known length. The image capture apparatus captures an image. Then based on the captured image, the feature extraction unit extracts at least three image feature points corresponding to the mark points. The processor calculates the inclination angle of the image capture apparatus, and the height between the image capture apparatus and the plane. Besides a line segment with a known length, the mark points corresponding to the image feature points may form a corner with a known angle, two corners with unknown but equal angles, or two line segments with unknown but equal lengths. Convenience for the calibration system is therefore improved.

### FIELD OF THE INVENTION

The present invention relates to a calibration system and a method for use in an image capture apparatus, and more particularly to a calibration system and a method that need a simple calibration appliance.

### BACKGROUND OF THE INVENTION

Currently digital interaction technology is widespread in electronic game entertainments, remote learning and the establishment of intelligence environments. In digital interaction, a positioning system is needed to calculate the positions or motions of the limbs of a user; or to calculate the position of a mark point and the movement of an object with a plurality of mark points. The positioning system is composed of a plurality of image capture apparatuses, like cameras. Every camera must be calibrated to obtain the camera parameters for spatial coordination. Once the mark points can be seen by two cameras, the 3-D spatial coordinates of the mark points can be calculated through the images captured by these cameras. Referring to FIG. 1, a schematic diagram illustrates a conventional camera calibration system. The camera calibration system 1 includes a camera 10, a calibration appliance 11, a captured image 12, a feature extraction unit 13 and an arithmetic unit 14. The calibration appliance 11 is for the calibration of the camera 10. The calibration appliance 11 includes a plurality of calibration reference mark points 111. The 3-D world coordinates 112 of every calibration reference mark point 111 must be known in advance. The camera 10 captures the image 12 for the calibration appliance 11. The feature extraction unit 13 extracts the image coordinates 121 of every mark point in the image 12. The arithmetic unit 14 then calculates a plurality of camera parameters of the camera 10, based on the 3-D world coordinates of the reference mark points 111 and the image coordinates 121 of the reference mark points 111. The accuracy of the 3-D world coordinates 112 of the calibration reference mark points 111 is a key factor in the calibration of the camera.

A conventional calibration system typically needs specific calibration appliances. In calibration, people need to place the calibration appliances within the viewing scope of the cameras. Modern security surveillance systems are usually disposed in a community environment, a parking lot or a warehouse. In the establishment of an intelligence environment, a PTZ camera that can pan, tilt, and zoom is usually used. For the kind of PTZ camera, a simple calibration process is required and conventional calibration processes may not be suitable. This is because once the posture of the camera is changed, system administrators may have to recalibrate all the cameras again with the specific calibration appliances.

To overcome the aforementioned shortcomings, the inventor of the present invention invents a calibration system and a method that only need a simple calibration appliance and can be easily used for the calibration of an image capture apparatus.

### SUMMARY OF THE INVENTION

The present invention provides a calibration system and a method that can be conveniently used in an image capture apparatus.

Based on the objective of the present invention, the calibration system includes a calibration appliance, a feature extraction unit and a processor. The calibration appliance has a plurality of mark points. The plurality of mark points is on the same plane and these mark points form a line segment with a known length. The feature extraction unit extracts at least three image feature points from at least one image captured by the image capture apparatus. Based on at least three image feature points on an image and the known lengths, the processor calculates the inclination angle of the image capture apparatus and the height between the image capture apparatus and the plane. Besides a line segment with a known length, the plurality of mark points, which is on the same plane, may also form a corner with a known angle, two comers with unknown but equal angles, or two line segments with unknown but equal lengths.

In addition, the present invention further provides a calibration method to be used in an image capture system with more than two image capture apparatuses. The method includes steps as follows:

(a) A plurality of mark points is disposed. The plurality of mark points is on the same plane. The plurality of mark points may form one line segment with a known length, a corner with a known angle, two corners with unknown but equal angles, or two line segments with unknown but equal lengths.

(b) An image capture apparatus, which has not been calibrated yet, captures at least one image of the plurality of mark points.

(c) At least three image feature points corresponding to the plurality of mark points are extracted from the captured images.

(d) The inclination angle of the image capture apparatus and the height between the image capture apparatus and the plane are calculated based on at least three extracted image feature points.

(e) Steps (b), (c) and (d) are repeated to calculate the inclination angles and the heights of all image capture apparatuses.

(f) For every pair of image capture apparatuses, the image points of two mark points commonly captured by these two image capture apparatuses are determined. Based on the image feature points of these mark points, together with the inclination angles and the heights of the image capture apparatus, the rotation angle and the position translation between these two image capture apparatuses are calculated

Other features and advantages of the present invention, as well as the variation thereof of the present invention, will become apparent from the following description, drawings, and claims.

### BRIEF DESCRIPTION OF THE DRAWINGS

FIG. 1 is a schematic diagram illustrating a conventional camera calibration system;

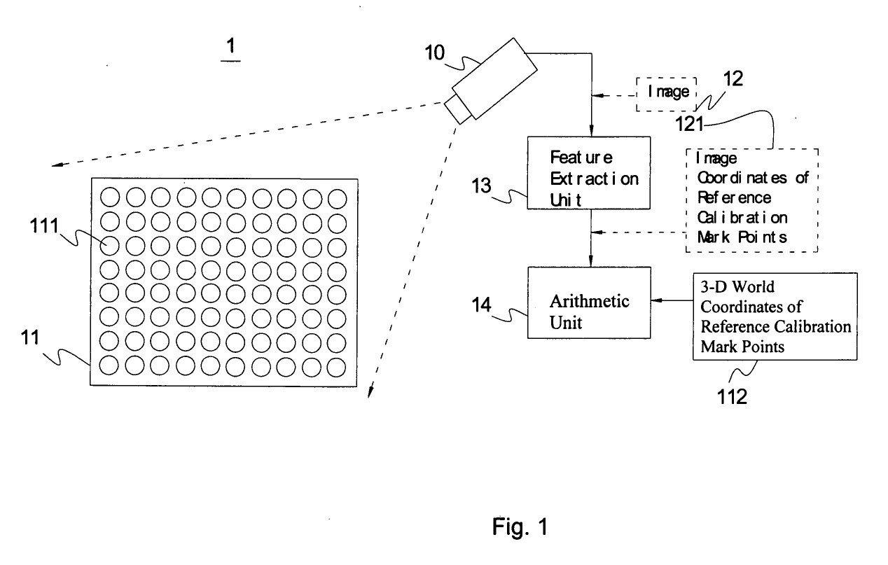

FIG. 2 is a schematic diagram illustrating a calibration system that can be applied to an image capture apparatus according to an embodiment of the present invention;

FIG. 3 is a schematic diagram illustrating a calibration system that can be applied to two image capture apparatuses according to an embodiment of the present invention;

FIG. 4 is the top view illustrating the setup of the two image capture apparatuses according to an embodiment of the present invention;

FIG. 5 is a schematic diagram illustrating a calibration system that can be applied to two image capture apparatuses according to a preferred embodiment of the present invention;

FIG. 6 is a schematic diagram illustrating traffic signs on a road surface that can be used as a calibration appliance according to an embodiment of the present invention;

FIG. 7 is a flowchart describing a calibration method that can be applied to more than two image capture apparatuses according to an embodiment of the present invention; and

FIG. 8 is a flowchart describing a calibration method that can be applied to more than two image capture apparatuses according to a preferred embodiment of the present invention.

### DETAILED DESCRIPTION OF THE PREFERRED EMBODIMENTS

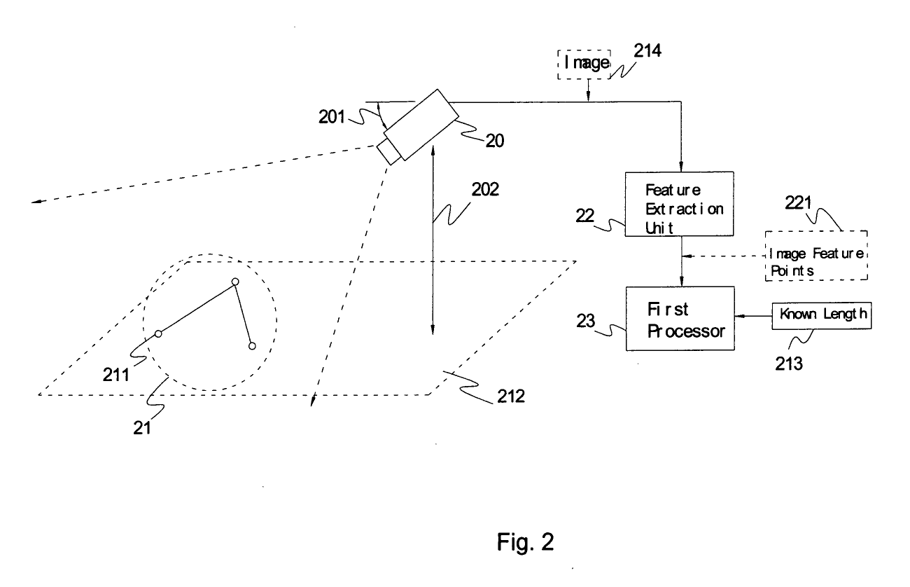

Referring to FIG. 2, a block diagram illustrates a calibration system according to an embodiment of the present invention. The calibration system is applied to an image capture apparatus. The calibration system 2 includes a calibration appliance 21, a feature extraction unit 22 and the first processor 23. The calibration appliance 21 has a plurality of mark points 211. The plurality of mark points 211 is on the same plane 212. The plurality of mark points 211 forms a line segment with a known length 213. The image 214 captured by the first image capture apparatus 20 has the image of the mark points 211. The feature extraction unit 22 extracts at least three image feature points 221 from the image 214. The first processor 23 calculates the inclination angle 201 of the first image capture apparatus and the height 202 between the first image capture apparatus 20 and the plane 212, based on the image feature points 221 and the known lengths 213. Besides a line segment with a known length, the plurality of mark points of the calibration appliance 21 may also be chosen to form a corner with a known angle, two comers with unknown but equal angle, or two line segments with unknown but equal length.

If the mark points of the calibration appliance 21 form a corner with an unknown angle, the calibration appliance 21 can be placed at more than two different positions on the plane. At each position, the image capture apparatus 20 captures the image 214 of the plurality of mark points. The feature extraction unit 22 then extracts the corresponding image feature points of the mark points. For instance, if the calibration appliance 21 has three mark points and the three mark points form a corner with unknown angle on a plane, the image capture apparatus 20 captures an image first. The position of the calibration appliance 21 is then changed. The image capture apparatus 20 then captures the second image. The feature extraction unit 22 then extracts the corresponding image feature points from each image. A similar procedure can be applied to a plurality of mark points which forms more than two line segments with unknown but equal length.

The mark points can be comers of a table, comers of a paper on the table, or patterns with comers on a plane. The image feature points corresponding to these kinds of mark points can be easily identified. The image capture apparatus 20 can be a camera.

In addition, the image capture apparatus can be equipped with an infrared ray filter and an infrared ray light emitting device. The infrared ray filter is added onto the image capture apparatus 20. The infrared ray emitting device is set with the image capture apparatus 20. We can place some objects which can reflect infrared ray on the mark points. Hence, the image feature points corresponding to the mark points can be more easily identified.

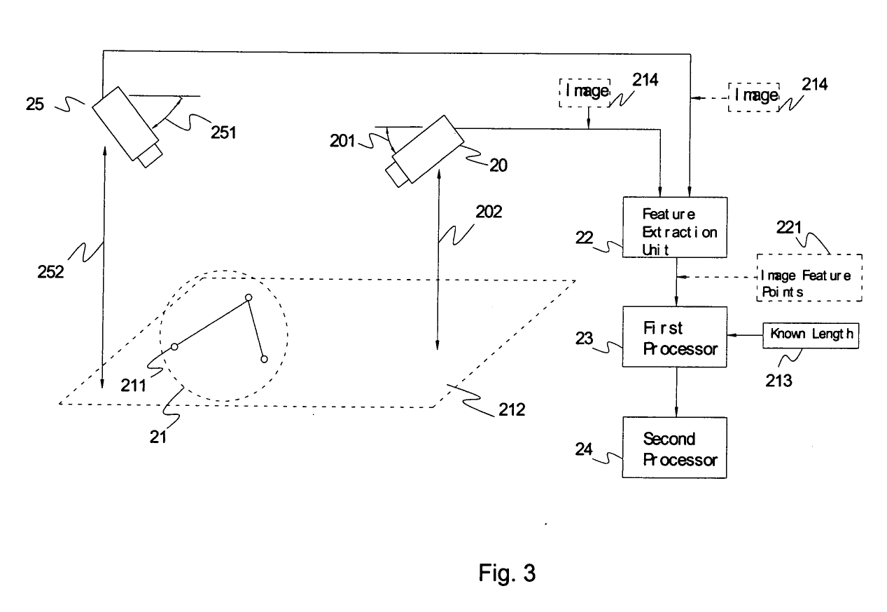

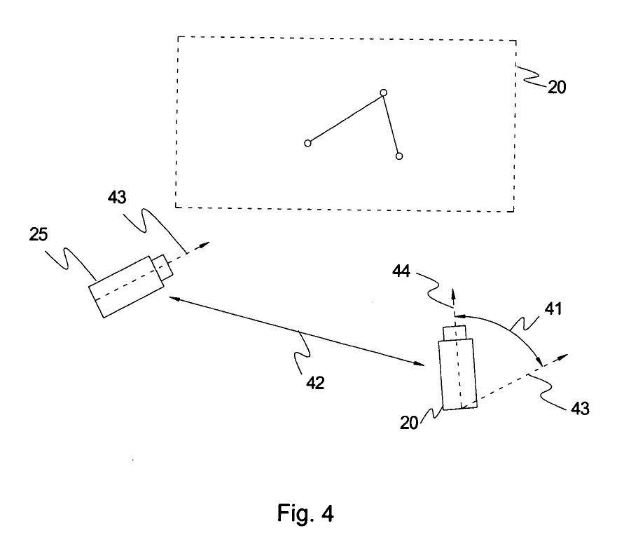

Moreover, the calibration system to be used for at least two image capture apparatuses further includes a second arithmetic unit for the calibration of a plurality of image capture apparatuses, as shown in FIG. 3. FIG. 4 illustrates the top view of the setup environment for the image capture apparatuses according to an embodiment of the present invention. The inclination angles 201, 251 and the heights 202, 252 of the first image capture apparatus 20 and the second image capture apparatus 25 are calculated based on the aforementioned calibration procedure. Afterward, a second arithmetic unit 24 determines a plurality of mark points which can be commonly observed by the first image capture apparatus 20 and the second image capture apparatus 25. Then, as shown in FIG. 4, the rotation angle 41 and the position translation 42 between the first image capture apparatus 20 and the second image capture apparatus 25 are calculated based on the image feature points corresponding to these mark points, the inclination angle 201 and the height 202 of the first image capture apparatus 20, and the inclination angle 251 and the height 252 of the second image capture apparatus 25. Here, the rotation angle 41 is the angle between the viewing direction 44 of the first image capture apparatus 20 and the viewing direction 43 of the second image capture apparatus 25.

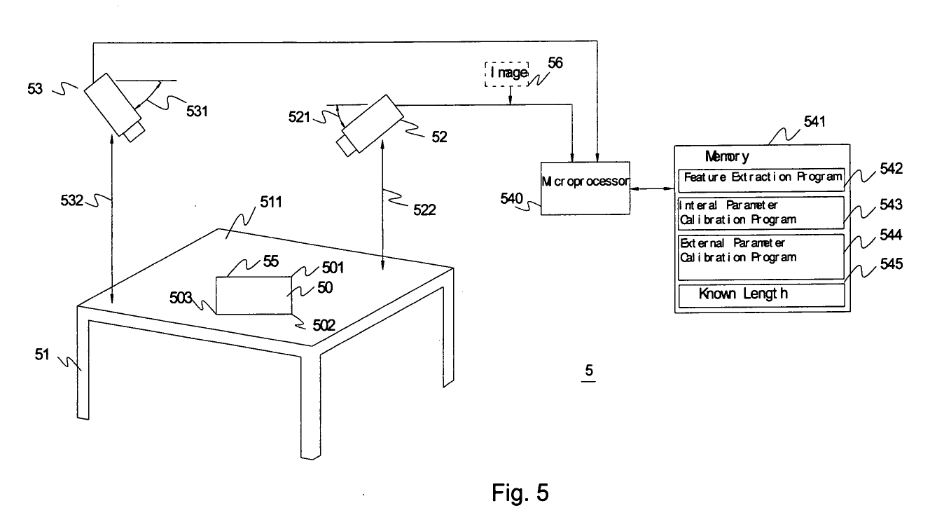

Referring to FIG. 5, a schematic diagram illustrates a calibration system to be used for at least two image capture apparatuses according to a preferred embodiment of the present invention. The calibration system 5 includes a sheet of paper 50, a table 51, a microprocessor 540 and a memory 541 for the calibration of the first camera 52 and the second camera 53. The memory 541 stores a feature extraction program 542, an internal parameter calibration program 543, and an external parameter calibration program 544. The color or intensity of the paper 50 is different from the color or intensity of the table 51. The boundary length 55 of the paper 50 is known and the four corner angles are ninety degrees. When the first camera 52 transmits a captured image 56 to the microprocessor 540, the microprocessor 540 executes the feature extraction program 542 to extract image feature points of the corners 501, 502 and 503 from the image 56. The microprocessor 540 then executes the internal parameter calibration program 543 to offer the internal parameters of cameras as the input to the external parameter calibration program 544. The microprocessor 540 then executes the external parameter calibration program 544 to calculate the inclination angle 521 and the height 522 between the first camera 52 and the tabletop 511 based on the image feature points of the corners 501, 502 and 503, the known length 545 of the boundary 55, and the ninety-degree corners. The inclination angle 531 and the height 532 between the second camera 53 and the tabletop 511 are also calculated through the aforementioned procedures. The microprocessor 540 then executes the external parameter calibration program 544 to calculate the rotation angle and the position translation between the first camera 52 and the second camera 53 based on the image feature points of the corners 501 and 502 of the paper, the inclination angles 521 and 531, and the heights 522 and 532.

If the color of the tabletop is different from the environment, the calibration system 5 may also use the corners of the tabletop 511 as mark points. The microprocessor 540 executes the feature extraction program 542 to extract image feature points of the corners of the tabletop 511 from the captured image.

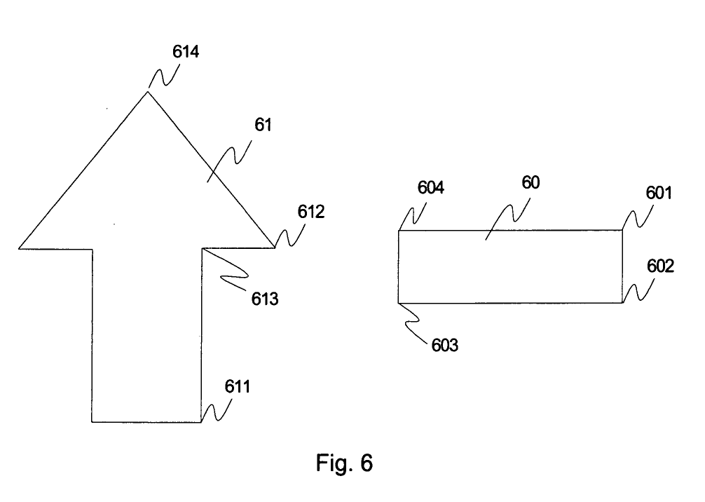

The calibration system of the present invention does not need complicated or specific calibration appliances. Once there is a plane in the calibration system environment and the plane has mark points with recognizable image feature points, the calibration of cameras can be achieved. In addition, as the cameras are under panning, tilting or zooming so that the calibration appliances are no longer visible, the calibration system may extract new image feature points from newly captured images to recalibrate the cameras. If the cameras are mounted outdoors, such as in a parking lot or on a roadside, some apparent traffic signs on the road surface can be utilized to calibrate cameras, like a direction sign and a stop sign shown in FIG. 6. The calibration system may calibrate the cameras based on the comers 601, 602, 603 and 604 of the stop sign 60, or the comers 611, 612, 613 and 614 of the direction sign 61. Once if the setup of the cameras is changed either by people or by the nature, the cameras may be conveniently recalibrated. There is no need to bring the calibration appliances to recalibrate the camera.

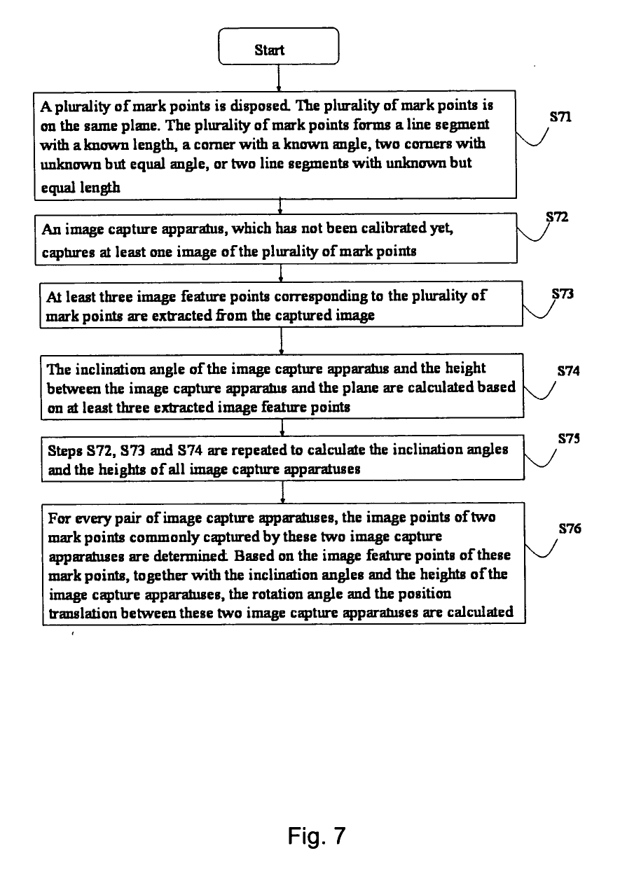

Referring to FIG. 7, a flowchart illustrates a calibration method according to an embodiment of the present invention. The calibration method is applied to a plurality of image capture apparatuses. The method includes steps as follows:

Step S71: A plurality of mark points is disposed. The plurality of mark points is on the same plane. The plurality of mark points forms a line segment with a known length, a corner with a known angle, two comers with unknown but equal angle, or two line segments with unknown but equal length.

Step S72: An image capture apparatus, which has not been calibrated yet, captures at least one image of the plurality of mark points.

Step S73: At least three image feature points corresponding to the plurality of mark points are extracted from the captured image.

Step S74: The inclination angle of the image capture apparatus and the height between the image capture apparatus and the plane are calculated based on at least three extracted image feature points.

Step S75: Steps S72, S73 and S74 are repeated to calculate the inclination angles and the heights of all image capture apparatuses.

Step S76: For every pair of image capture apparatuses, the image points of two mark points commonly captured by these two image capture apparatuses are determined. Based on the image feature points of these mark points, together with the inclination angles and the heights of the image capture apparatuses, the rotation angle and the position translation between these two image capture apparatuses are calculated.

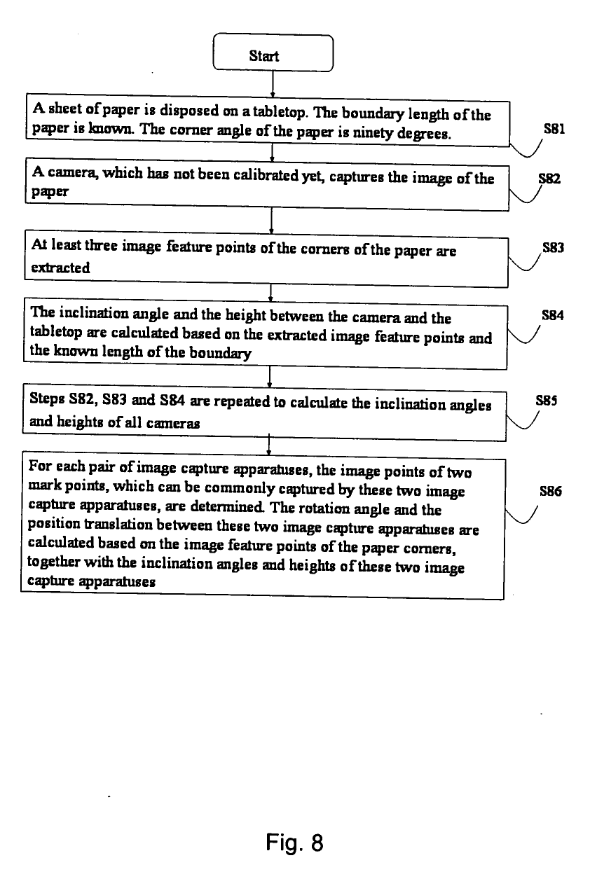

Referring to FIG. 8, a flowchart illustrates a calibration method according to a preferred embodiment of the present invention. The calibration method is applied to a plurality of image capture apparatuses. The method includes steps as follows:

Step S81: A sheet of paper is disposed on a tabletop. The boundary length of the paper is known. The corner angle of the paper is ninety degrees.

Step S82: A camera, which has not been calibrated yet, captures the image of the paper.

Step S83: At least three image feature points of the corners of the paper are extracted.

Step S84: The inclination angle and the height between the camera and the tabletop are calculated based on the extracted image feature points and the known length of the boundary.

Step S85: Steps S82, S83 and S84 are repeated to calculate the inclination angles and heights of all cameras.

Step S86: For each pair of image capture apparatuses, the image points of two mark points, which can be commonly captured by these two image capture apparatuses, are determined. The rotation angle and the position translation between these two image capture apparatuses are calculated based on the image feature points of the paper corners, together with the inclination angles and heights of these two image capture apparatuses.

Although the features and advantages of the embodiments according to the preferred invention are disclosed, it is not limited to the embodiments described above, but encompasses any and all modifications and changes within the spirit and scope of the following claims.

What is claimed is:

1. A calibration system to be used in an image capture apparatus, comprising:
a calibration appliance with a plurality of mark points, said plurality of mark points being on the same plane, said plurality of mark points forming a line segment with a known length;
a feature extraction unit extracting at least three image feature points corresponding to said plurality of mark points from at least one image captured by said image capture apparatus, said image having said plurality of mark points; and
a processor calculating the inclination angle of said image capture apparatus and the height between said image capture apparatus and said plane based on said at least three image feature points and said known lengths;
wherein said plurality of mark points corresponding to said image feature points forms a corner with a known angle, two corners with unknown but equal angles, or two line segments with unknown but equal lengths.

2. The calibration system of claim 1, wherein said plurality of mark points forms an unknown angle, and said image capture apparatus captures the images of said calibration appliance placed at different positions on said plane, and said feature extraction unit extracts said image feature points from said images.

3. The calibration system of claim 1, wherein said calibration appliance has two mark points, and said image capture apparatus captures the images of said calibration appliance placed at different positions on said plane, and said feature extraction unit extracts said image feature points from said images.

4. The calibration system of claim 1, wherein said image capture apparatus is a camera.

5. The calibration system of claim 1, wherein said calibration appliance is a paper, a table or a traffic sign drawn on a road surface.

6. The calibration system of claim 5, wherein said plurality of mark points is the corners of said paper.

7. The calibration system of claim 5, wherein said plurality of mark points is the corners of said table.

8. The calibration system of claim 5, wherein said plurality of mark points is the corners of said traffic sign drawn on the road surface.

9. The calibration system of claim 1, wherein said feature extraction unit is accomplished by a microprocessor executing software.

10. A calibration system to be used in a plurality of image capture apparatuses, comprising:
a calibration appliance with a plurality of mark points, said plurality of mark points being on the same plane, and said plurality of mark points forming a line segment with a known length;
a feature extraction unit extracting at least three image feature points corresponding to said plurality of mark points from at least one image captured by said image capture apparatus, said image having said plurality of mark points;
a first arithmetic unit calculating the inclination angle of said image capture apparatus and the height between said image capture apparatus and said plane based on said at least three image feature points and said known length; and
a second arithmetic unit determining two mark points commonly captured by each pair of said image capture apparatuses, and calculating the rotation angle and the position translation between said plurality of image capture apparatuses based on said image feature points corresponding to said mark points, said inclination angles and said heights of said plurality of image capture apparatuses;
wherein said plurality of mark points corresponding to said image feature points forms a corner with a known angle, two comers with unknown but equal angle or two line segments with unknown but equal length.

11. The calibration system of claim 10, wherein said plurality of mark points forms an unknown angle, and said image capture apparatus captures the images of said calibration appliance placed at different positions on said plane, and said feature extraction unit extracts said image feature points from said images.

12. The calibration system of claim 10, wherein said calibration appliance has two mark points, and said image capture apparatus captures the images of said calibration appliance placed at different positions on said plane, and said feature extraction unit extracts said image feature points from said images.

13. The calibration system of claim 10, wherein said calibration apparatus is a camera.

14. The calibration system of claim 10, wherein said calibration appliance is a paper, a table or a traffic sign drawn on a road surface.

15. The calibration system of claim 14, wherein said plurality of mark points is the comers of said paper.

16. The calibration system of claim 14, wherein said plurality of mark points is the corners of said table.

17. The calibration system of claim 14, wherein said plurality of mark point is the corners of said traffic sign drawn on the road surface.

18. The calibration system of claim 10, wherein said feature extraction unit is accomplished by a microprocessor executing software.

19. A calibration method to be used in a plurality of image capture apparatuses, comprising:
(a) disposing a calibration appliance with a plurality of mark points, said plurality of mark points being on the same plane, and said plurality of mark points forming a line segment with a known length, and a corner with a known angle, two corners with unknown but equal angles or two line segments with unknown but equal lengths;
(b) capturing at least one image having said plurality of mark points by an image capture apparatus, said an image capture apparatus not being calibrated.
(c) extracting at least three image feature points corresponding to said plurality of mark points from said at least one image;
(d) calculating the inclination angle of said image capture apparatus, and the height between said image capture apparatus and said plane based on said at least three image feature points and said known length;
(e) repeating steps (b), (c) and (d) to calculate said inclination angles and said heights of said plurality of image capture apparatuses;
(f) determining two mark points commonly captured by each pair of said image capture apparatuses, and calculating the rotation angle and the position translation between said plurality of image capture apparatuses based on said image feature points corresponding to said mark points, said inclination angles and said heights of said plurality of image capture apparatuses.

20. The calibration method of claim 19, further comprising the step of capturing the images of said calibration appliance placed at different positions on said plane if said plurality of mark points forms an unknown angle, and extracting image feature points based on said images.

21. The calibration method of claim 19, further comprising the step of capturing the images of said calibration appliance placed at different positions on said plane when said calibration appliance with two mark points.

22. The calibration method of claim 19, further comprising the step of providing cameras to be said plurality of image capture apparatuses.

23. The calibration method of claim 19, further comprising the step of providing a paper, a table or a traffic sign drawn on a road surface.

24. The calibration method of claim 23, further comprising the step of providing the corners of said paper to be said mark points.

25. The calibration method of claim 23, further comprising the step of providing the corners of said table to be said mark points.

26. The calibration method of claim 23, further comprising the step of providing the corners of said traffic sign drawn on the road surface to be said mark points.

27. The calibration method of claim 19, further comprising the step of providing a microprocessor executing software to accomplish said feature extraction unit.
